(19) United States
(12) Patent Application Publication
(10) Pub. No.: US 2008/0163183 A1
(43) Pub. Date: Jul. 3, 2008

(54) METHODS AND APPARATUS TO PROVIDE PARAMETERIZED OFFLOADING ON MULTIPROCESSOR ARCHITECTURES

(76) Inventors: Zhiyuan Li, West Lafayette, IN (US); Xinmin Tian, Union City, CA (US); Wei Li, Redwood Shores, CA (US); Hong Wang, Fremont, CA (US)

Correspondence Address: Hanely Flight & Zimmerman, LLC, 150 S. Wacker Drive, Suite 2100, Chicago, IL, 60606, US

(21) Appl. No.: 11/618,143

(22) Filed: Dec. 29, 2006

(51) Int. Cl. G06F 9/45

(52) U.S. Cl. 717/149

(57) ABSTRACT

Methods and apparatus to provide parameterized offloading in multiprocessor systems are disclosed. An example method includes partitioning source code into a first task and a second task, and compiling object code from the source code, such that the first task is compiled to execute on a first processor core and the second task is compiled to execute on a second processor core, the assignment of the first task to the first core being dependent on an input parameter.

### TECHNICAL FIELD

This disclosure relates generally to program management, and, more particularly, to methods, apparatus, and articles of manufacture to provide parameterized offloading on multiprocessor architectures.

### BACKGROUND

In order to increase performance of information processing systems, such as those that include microprocessors, both hardware and software techniques have been employed. On the hardware side, microprocessor design approaches to improve microprocessor performance have included increased clock speeds, pipelining, branch prediction, super-scalar execution, out-of-order execution, and caches. Many such approaches have led to increased transistor count, and have even, in some instances, resulted in transistor count increasing at a rate greater than the rate of performance improvement.

Rather than seek to increase performance through additional transistors, other performance enhancements involve software techniques. One software approach that has been employed to improve processor performance is known as “multithreading.” In software multithreading, an instruction stream is split into multiple instruction streams, or “threads,” that can be executed concurrently.

Increasingly, multithreading is supported in hardware. For instance, processors in a multiprocessor (“MP”) system, such as a single chip multiprocessor (“CMP”) system wherein multiple cores are located on the same die or chip and/or a multi-socket multiprocessor system (“MS-MP”) wherein different processors are located in different sockets of a motherboard (each processor of the MS-MP might or might not be a CMP), may each act on one of the multiple threads concurrently. In CMP systems, however, homogenous multi-core chips (i.e., multiple identical cores on a single chip) consume large amounts of power. Because many applications, programs, tasks, threads, etc. differ in execution characteristics, heterogeneous multi-core chips (i.e., multiple cores with differing areas, frequency, etc. on a single chip) have been developed to mirror/accommodate these diversities and, thus, limit total energy consumption and increase total execution speed. Heterogeneous multi-core processors are referred to herein as “H-CMP systems.” As used herein, the term “CMP systems” is generic to both H-CMP systems and homogeneous multi-core systems. As used herein, the term “MP system” is generic to H-CMP systems and MS-MP systems.

### BRIEF DESCRIPTION OF THE DRAWINGS

FIG. 1 illustrates an example parameterized compiler.

FIG. 2 is a schematic illustration of the example parameterized compiler of FIG. 1.

FIG. 3 illustrates example pseudocode that may implement the source code of FIG. 1 and an illustrated control flow created by the parameterized compiler of FIG. 1.

FIG. 4 is a flowchart representative of example machine readable instructions, which may be executed to implement the example parameterized compiler of FIG. 1.

FIG. 5 is a schematic illustration of an example chip multiprocessor (“CMP”) system, which may be used to execute the object code of FIGS. 1 and/or 3.

FIG. 6 is a schematic illustration of an example processor system, which may be used to implement the example parameterized compiler of FIG. 1 and/or the example chip multiprocessor system of FIG. 4.

### DETAILED DESCRIPTION

As described in detail below, by modifying source code, object code is formed such that, when executed, the object code includes partitioned tasks that are computationally determined to either execute the task on a first processor core or offload the task to execute on one or more other processor cores (i.e., not the first processor core) in an MP system. The determination of whether to offload a particular task depends on parameterized offloading formulas that include a set of input parameters for each task, which capture the effect of the task execution on the MP system. The MP system may be a chip multiprocessor (“CMP”) system or a multi-socket multiprocessor (“MS-MP”) system, and the formulas and/or inputs thereto are adjusted to the particular architecture (e.g., CMP or MS-MP). The parameterized offloading approach described below enables parameters, such as data size of the task and other execution options, to be input at run time because these parameters may not be known during compile time. For example, source code may provide a video program that decodes, edits, and displays an encoded video. From this example source code, the example object code is created to adapt the run-time offloading decision to the example execution context, such as whether the construct requires decoding and displaying the video or decoding and editing the video. In addition, the example object code is created to adapt the run-time offloading decision to the size of the encoded video.

Although the teachings of this disclosure are applicable to all MP systems including MS-MP systems and CMP systems, for ease of discussion, the following description will focus on a CMP system. Persons of ordinary skill in the art will recognize that the selection of a CMP system to illustrate the principles disclosed herein is not meant to imply that those principles are limited to CMP architectures. On the contrary, as previously stated, the principles of this disclosure are applicable across all MP architectures including MS-MP architectures.

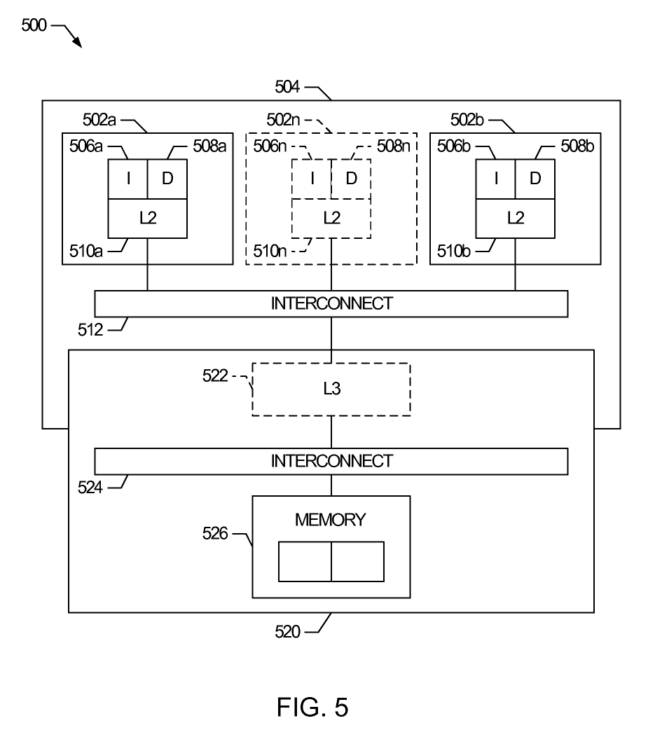

A chip multiprocessor (“CMP”) system, such as the system 500 illustrated in FIG. 5 and described below, provides for running multiple threads via concurrent thread execution on multiple cores (e.g., processor cores 502a-502n) on the same chip. In such CMP systems, one or more cores may be configured to, for example, coordinate main program flow, interact with an operating system, and execute tasks that are not offloaded (referred herein as a “main core” or “MC”); and one or more cores may be configured to execute tasks offloaded from the main core (referred herein as “helper core(s)” or “HCs”). In some example CMP systems (e.g., heterogeneous CMP systems), the main core runs at a relatively high frequency and the helper core(s) run at a relatively lower frequency. In some example CMP systems, the helper core(s) might also support instruction set extension specialized for data-level parallelism with vector instructions while the main core does not support the same extension. Thus, a program partitioned into tasks that are offloaded from a main core to helper core(s) may reduce execution times and reduce power consumption on the CMP system.

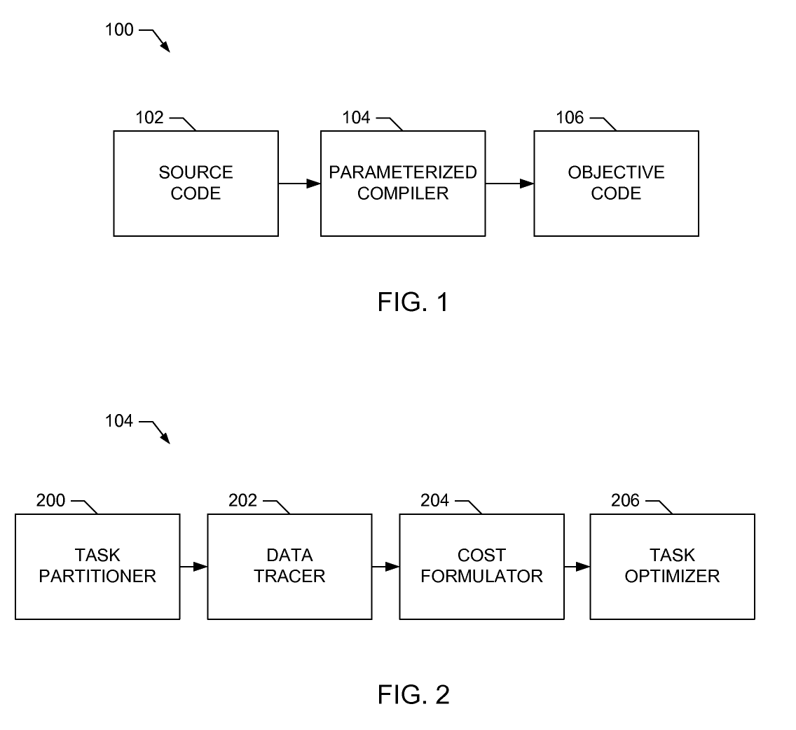

FIG. 1 is a schematic illustration of an example system 100 including source code 102, a parameterized compiler 104, and object code 106. The source code 102 may be in any computer language, including a human-readable source code or machine executable code. As described below, the parameterized compiler 104 is structured to read the source code 102 and produce object code 106, which may be in any form of a human-readable code or machine executable code. In some example implementations, the object code 106 is machine executable code with parameterized offloading, which may be executed by the CMP system 500 of FIG. 5. In other examples, the object code 106 is machine executable code with parameterized offloading, which may be executed by MP systems of different architectures (e.g., MS-MP system, etc.). In an MS-MP example, the main core (“MC”) and helper core(s) (“HC”) described below may be different chips. The example parameterized offloading includes partitioned tasks associated with a set of input parameters, which are evaluated to determine whether to execute a particular task on a first processor core or offload the task to execute on a second processor core.

FIG. 2 is an example schematic illustration of the parameterized compiler 104 of FIG. 1. In the example of FIG. 2, the compiler 104 includes a task partitioner 200, a data tracer 202, a cost formulator 204, and a task optimizer 206. The task partitioner 200 obtains source code 102 (see, e.g., FIG. 1) and categorizes the source code 102 as one or more tasks. The example data tracer 202 of FIG. 2 evaluates the data dependences for the various execution contexts of the source code 102 of FIG. 1. The example cost formulator 204 establishes cost formulas that are minimized by the task optimizer 206 to determine the values of each task assignment decision for one or more sets of input parameters.

As noted above, the task partitioner 200 obtains source code 102 and categorizes the source code 102 as one or more tasks. In the discussion herein, a “task” may be a consecutive segment of the source code 102, which is delineated by control flow statements (e.g., a branch instruction, an instruction following a branch instruction, a target instruction of a branch instruction, function calls, return instructions, and/or any other type of control transfer instruction). Tasks may also have multiple entry points such as, for example, a sequential loop, a function, a series of sequential loops and function calls, or any other instruction segment that may reduce scheduling and communication between multiple cores in a MP system. During execution, a task may be fused, aligned, and/or split for optimal use of local memory. That is, tasks need not be consecutive addresses of machine readable instructions in local memory. The remaining portion of the source code 102 that is not categorized into tasks may be represented as a unique task, referred to herein as a super-task.

The task partitioner 200 of the illustrated example constructs a graph (V,E), wherein each node V denotes a task and an edge E denotes that, under certain control flow conditions, a task vⱼ executes immediately after task vᵢ (i.e., e=(vᵢ,vⱼ)εE). As discussed below, each of the tasks is assigned to execute on a main core or helper core using the organization of this constructed graph. Also discussed below, the decision to execute a particular task can be formulated dependent on a Boolean value, which can be determined by a set of input parameters at run time. In an example implementation, the task assignment decision M(v) for each task V is represented such that:

$$M ( v ) = \{ \begin{matrix}1 & task v is executed on the helper core ( s ) \\ 0 & task v is executed on the main core\end{matrix}$$

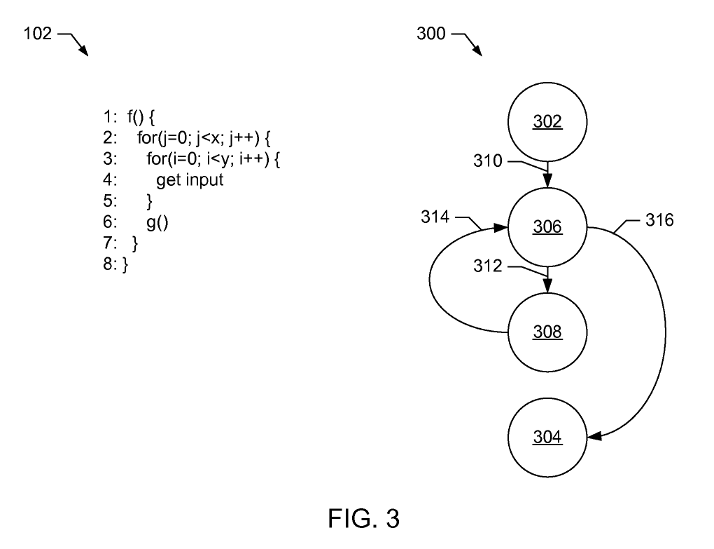

FIG. 3 provides example source code which may correspond to the source code 102 of FIG. 1 and an example graph 302 that is constructed by the task partitioner 200 of FIG. 2. In the discussion herein, a line number is provided as a parenthetical expression (i.e., line #), for a reference to the respective instruction on that line number. The pseudocode of the example sources code 102 originates with a function call “f( )” (line 1) that begins with an opening bracket “{” (line 1) and ends with a closing bracket “}” (line 8). After the function call, a first “for loop” construct begins with an opening bracket “{” (line 2) and ends with a closing bracket “} ” (line 7). The first for loop construct executes a block of code (lines 3-6) given a particular initialization “j=0”, test condition “j<x”, and increment value “j++”. The function call “f( )” and the first for loop construct demonstrates an example super-task, which are represented in the example graph 300 as entry node 302 and exit node 304. Within the block of code (lines 3-6) of the first for loop construct is a second for loop construct, which begins with an opening bracket “{” (line 3) and ends with a closing bracket “}” (line 5). The second for loop construct executes a block of code (line 4) given a particular initialization “i=0”, test condition “i<y”, and increment value “i++”. The second for loop construct demonstrates a first task, which is represented in the example graph 300 as node 306. The first for loop also includes a function call “g( )”, which demonstrates a second task that is represented in the example graph 300 as node 308. Thus, the execution sequence of the example source code 102 is represented with edge 310 from entry node 302 to node 306 (e.g., the second for loop), edge 312 from node 306 (e.g., the second for loop) to node 308 (e.g., the function call “g( )”), edge 314 from node 308 (e.g., the function call “g( )”) to node 306 (e.g., the second for loop), and edge 316 from node 306 (e.g., the function call “g( )”) to exit node 304.

The task partitioner 200 of the illustrated example inserts a conditional statement, such as, for example an if, jump, or branch statement, that uses input parameters, as described below, to determine the task assignment decision for one or more partitioned tasks. The conditional statement evaluates the set of input parameters against a set of solutions to determine whether an offloading condition is met. The input parameters may be expressed as a single vector and, thus, the conditional statement may evaluate a plurality of input parameters via a single conditional statement associated with the vector. Dependent on the solution to the task assignment decision, a subsequent instruction may be executed to offload execution of the task to the helper core(s) (e.g., M(v)=1 to offload task execution to the helper core(s)) or the subsequent instruction may not be executed to continue execution of the task on the main core (e.g., M(v)=0 to continue task execution on the main core).

The task partitioner 200 of the illustrated example also inserts a content transfer message(s), which, when executed, offloads one or more tasks after the conditional statement evaluates the task assignment decision and determines to offload the task execution (e.g., M(v)=1 to offload a task). The content transfer message may be, for example, one or more of get, store, push, and/or pull messages to transfer instruction(s) and/or data from the main core local memory to the helper core(s) local memory, which may be in the same or different address space(s). For example, the contents (e.g., instruction(s) and/or data) may be loaded to the helper core(s) through a push statement on the main core and a store statement on the helper core(s) with example argument(s) such as, for example, one or more helper core identifier(s), the size of the block to push/store, the main core memory address of the block to push/store, and/or the local address of the block(s) to push/store. Similarly, the content transfer messaging may be implemented via inter-processor interrupt (IPI) mechanism between the main core(s) and the helper core(s). Persons of ordinary skill in the art will understand similar implementation may be provided for the helper core(s) to get or pull the contents from the main core.

In addition to the content transfer message(s), the task partitioner 200 of the illustrated example also inserts a control transfer message(s) to signal a control transfer of one or more tasks to the helper core(s) after the conditional statement evaluates the task assignment decision and determines to offload the task execution (e.g., M(v)=1 to offload a task). The control message(s) may include, for example, an identification of the set or subset of the helper cores to execute the task(s), the instruction address(es) in the address space for the task(s), and a pointer to the memory address, which is unknown until run time for the task(s), for the execution context (e.g., the stack frame). The task partitioner 200 may also insert a statement to lock a particular helper core, a subset of the helper core(s), or all of the helper cores before one or more tasks are offloaded from the main core. If the statement to lock the helper core(s) fails, the tasks may continue to execute on the main core.

The task partitioner 200 of the illustrated example also inserts a control transfer message after each task to signal a control transfer to the main core after the helper core completes an offloaded task. An example control transfer message may include sending an identifier associated with the helper core to a main core to notify the main core that task execution has completed on the helper core. The task partitioner 200 may also insert a statement to unlock the helper core if the main core acknowledges receiving the control transfer message.

To transform the source code 102 of FIG. 1 into the object code 106 of FIG. 1 with parameterized offloading, the data tracer 202 of FIG. 2 evaluates the data dependencies for the various execution contexts among the partitioned tasks from the source code 102 of FIG. 1. Because control and data flow information may not be determined at compile time, in this example (e.g., a CMP architecture), the data tracer 202 represents the memory to be accessed at run time by a set of abstract memory locations, which may include code object and data object locations. The data tracer 202 represents the relationship between each abstract memory locations and run-time memory address with pointer analysis techniques that obtain relationships between memory locations. The data tracer 202 statically determines the data transfers of the source code 102 in terms of the abstract memory locations and inserts message passing primitives for the data transfers.

At run time, dynamic bookkeeping functions map the abstract memory locations to physical memory locations using message passing primitives to determine the exact data memory locations. The dynamic bookkeeping function is based on a registration table and a mapping table. In an example CMP system with separate private memory for a main core and each helper core respectively, a registration table establishes an index of the abstract memory locations for lookup with a list of the physical memory addresses for each respective abstract memory location. The main core also maintains a mapping table, which contains the mapping of the physical memory addresses for the same data objects on the main core and the helper core(s). The dynamic bookkeeping function translates the representation of the data objects such that data objects on the main core are translated and sent to the helper core(s), and data objects on the helper core(s) are sent to the main core and translated on the main core. To reduce run-time overhead, the dynamic bookkeeping function may only map dynamically allocated data objects, which are accessed by both the main core and helper core(s). For example, for each dynamically allocated data item d, the data tracer 202 creates two Boolean variables for the data access states including:

$${N}_{m} ( d ) = \{ \begin{matrix}1 & data object d is accessed on the main core \\ 0 & data object d is not accessed on the main core\end{matrix} \\ {N}_{h} ( d ) = \{ \begin{matrix}1 & data object d is accessed on the helper core ( s ) \\ 0 & data object d is not accessed on the helper core ( s )\end{matrix}$$

The communication overhead between shared data can be determined by the amount of data transfer that is required among tasks and whether these tasks are assigned to different cores. For example, if an offloaded task (i.e., a task to execute on a helper core) reads data from a task that is executed on a main core, communication overhead is incurred to read the data from the main core memory. Conversely, if a first offloaded task reads data from a second offloaded task, a lower communication overhead is incurred to read the data if the first and second offloaded tasks are handled by the same helper core. Thus, the communication overhead for each task is in part determined by data validity states as described below. For example, the data validity states for a particular data object d that appears in a super-task V are represented as Boolean variables including:

$${V}_{m} ( e , d ) = \{ \begin{matrix}1 & data object d is valid immediately before edge e on MC \\ 0 & data object d is invalid immediately before edge e on MC\end{matrix} \\ {V}_{m} ( e , d ) = \{ \begin{matrix}1 & data object d is valid immediately after edge e on MC \\ 0 & data object d is invalid immediately after edge e on MC\end{matrix} \\ {V}_{h} ( e , d ) = \{ \begin{matrix}1 & data object d is valid immediately before edge e on HC \\ 0 & data object d is invalid immediately before edge e on HC\end{matrix} \\ {V}_{h} ( e , d ) = \{ \begin{matrix}1 & data object d is valid immediately after edge e on HC \\ 0 & data object d is invalid immediately after edge e on HC\end{matrix}$$

Also for example, the data validity states for a particular data object d that appears in a task V are represented as four Boolean variables including:

$${V}_{m , i} ( v , d ) = \{ \begin{matrix}1 & data object d is valid on MC at task v entry \\ 0 & data object d is invalid on MC at task v entry\end{matrix} \\ {V}_{m , o} ( v , d ) = \{ \begin{matrix}1 & data object d is valid on MC at task v exit \\ 0 & data object d is invalid on MC at task v exit\end{matrix} \\ {V}_{h , i} ( v , d ) = \{ \begin{matrix}1 & data object d is valid on HC at task v entry \\ 0 & data object d is invalid on HC at task v entry\end{matrix} \\ {V}_{h , o} ( v , d ) = \{ \begin{matrix}1 & data object d is valid on HC at task v exit \\ 0 & data object d is invalid on HC at task v exit\end{matrix}$$

From the data validity states, offloading constraints for data, tasks, and super-tasks of the example source code 102 of FIG. 1 are determined including read constraints, write constraints, transitive constraints, conservative constraints, and data-access state constraints. The read constraints bounds a local copy of a data object (e.g., data stored in local memory of a main core or a helper core) to be valid before each read. That is, if a task V has an upwardly exposed read (e.g., read of a data object outside of task v) of data object d, the data object d must be valid before entry of the task V. This statement can be conditionally written as M(v)→V_{h,i}(v,d) and [symbol] M(v)→V_{m,i}(v,d). In the discussion herein, the symbol → is used to represent logical implication or material conditionality and the symbol [symbol] is used to represent logical negation. For a super-task, the data validity is traced to the incoming edges of the super-task and, thus, the read constraint may bound an upwardly exposed read of data object d with a conservative approach of Vₘ(e,d)=1 and Vₕ(e,d)=0 for all incoming edges e to the super-task.

The write constraint region that, after each write to a data object, the local copy of the data object (e.g., the data object written to local memory of a helper core) is valid and the remote copy of the data object (e.g., the data object stored in local memory of a main core) is invalid. That is, if a task V writes to data object d in local memory, the data object d is valid before entry of the task V. This statement may be conditionally written as M(v)→V_{h,i}(v,d) and [symbol] M(v)→V_{m,i}(v,d). For a super-task, the write constraint may bound a write to a data object d that reaches an outgoing edge e to a particular task V with a conservative approach of Vₘ(e,d)=1 and Vₕ(e,d)=0.

In the illustrated example, the transitive constraint requires that, if a data object is not modified in a task, the validity state of the data object is unchanged. That is, if a data object d is not written or otherwise modified in a task v, the local copy of the data object d is valid. This statement may be conditionally written as V_{h,o}(v,d)=V_{h,i}(v,d) and V_{m,o}(v,d)=V_{m,i}(v,d). For a super-task, the transitive constraint is traced between an incoming edge and outgoing edge (both relative to the super-task) such that the local copy of a data object d is valid if the data object d is not written or otherwise modified between these edges. The transitive constraint for a super-task may be conditionally written as Vₕ(e1,d)=Vₕ(e2,d) and Vₘ(e1,d)=Vₘ(e2,d) for a data object d that is not modified between an incoming edge e1 and an outgoing edge e2 on a helper core and main core, respectively.

In the illustrated example, the conservative constraint requires a data object that is conditionally modified in a task to be valid before a write occurs. Thus, if a task V conditionally or partially writes or otherwise modifies data object d in local memory, the data object d must be valid before entry of the task V. The statement may be conditionally written as M(v)→V_{h,i}(v,d) and [symbol] M(v)→V_{m,i}(v,d). For a super-task, the conservative constraint may bound a conditional write or other potential modification of a data object d along some incoming edge e to a particular task V with a conservative approach of Vₘ(e,d)=1 and Vₕ(e,d)=0.

In the illustrated example, the data access constraint requires that, if a data object d is accessed in a task v, the task assignment decision M(v) implies the data access state variable. This statement may be conditionally written as M(v)→Nₕ(d) and [symbol] M(v)→Nₘ(d). That is, if task V is executed on the main core, then data object d is assessed on the main core. Conversely, if task V is executed on the helper core(s), then data object d is assessed on the helper core(s).

Persons of ordinary skill in the art will readily recognize that the above example referenced a CMP system with a non-shared memory architecture. However, the teachings of this disclosure are applicable to any type of MP application (e.g., CMP and/or MS-MP systems) employing any type of memory architecture (e.g., shared or non-shared). In the shared memory context, the cost of communication is significantly simplified, assuming uniform memory access. For non-uniform memory access, the cost of communication can be determined based on the employed topology using established parameterization techniques, and the equations discussed herein can be modified to incorporate that parameterization.

Returning to the shared memory, CMP example, to transform the source code 102 of FIG. 1 into object code 106 with parameterized offloading, the cost formulator 204 establishes cost formulas that can be reduced and solved at run time. The cost formulator 204 establishes computation, communication, task-scheduling, address-translation, and data-redistribution cost formulas for the source code 102 of FIG. 1, which can be solved and minimized via input parameters and/or constant(s) with the object code 106 of FIG. 1. As discussed below, the input costs for these cost formulas may be run-time values and, thus, the cost formulator 204 may express the input costs as formulas with input parameters in the object code 106 of FIG. 1 that can be provided at run-time.

In the illustrated example, the computation cost is the cost of task execution on the assigned core. If task V is assigned to the helper core(s) (i.e., M(v)=1), the helper core(s) computation cost Cₕ(v) is charged to task V execution. Alternatively, if task V is assigned to the main core (i.e., M(v)=0), the main core computation cost Cₘ(v) is charged to task V execution. The computation cost Cₕ(v) may be, for example, the sum of the products of the average time to execute an instruction i on the helper core(s) and the execution count of the instruction i in task v. Similarly, the computation cost Cₘ(v) may be, for example, the sum of the products of the average time to execute an instruction i on the main core and the execution count of the instruction i in task v. Thus, the cost formulator 204 can develop the total computation cost of all tasks by summing all the computation costs assigned to the main core and all the computed costs assigned to the helper cores for each task. This summation can be written as the following expression.

$${\sum }_{All v} M ( v ) {C}_{h} ( v ) + M ( v ) {C}_{m} ( v )$$

In the illustrated example, the communication cost is the cost of data transfer between the helper core(s) and the main core. If data object d is transferred from the main core to the helper core(s) along the control edge e=(vᵢ,vⱼ) in the task graph, the data validity states are V_{h,o}(vᵢ,d)=0 and V_{h,i}(vⱼ,d)=1 in accordance with the above-discussed constraints. Thus, the data transfer cost from the main core to the helper core(s) D_{m,h}(vᵢ,vⱼ,d) is charged to edge e. Similarly, if data object d is transferred from the helper core(s) to the main core on edge e (i.e., V_{m,o}(vᵢ,d)=0 and V_{m,i}(vⱼ,d)=1), the data transfer cost from the helper core(s) to the main core D_{h,m}(vᵢ,vⱼ,d) is charged to edge e. The data transfer cost from the main core to the helper core(s) D_{m,h}(vᵢ,vⱼ,d) may be, for example, the sum of the products of the time to transfer data object d from the main core to the helper core(s) and the execution count of the control edge e that transfers data object d. Similarly, the data transfer cost from the helper core(s) to the main core D_{h,m}(vᵢ,vⱼ,d) may be, for example, the sum of the products of the time to transfer data object d from the helper core(s) to the main core and the execution count of the control edge e that transfers data object d. Thus, the cost formulator 204 establishes a cost formula for communication costs for all edges with data object transfers excluding super-tasks by the following expression.

$${\sum }_{( {v}_{i} , {v}_{j} ) , d ; where {v}_{i} is a super \text{-} task} {V}_{h} ( e , d ) {V}_{h , i} ( {v}_{j} , d ) {D}_{m , h} ( {v}_{i} , {v}_{j} , d ) + {V}_{m} ( e , d ) {V}_{m , j} ( {v}_{j} , d ) {D}_{h , m} ( {v}_{i} , {v}_{j} , d ) + {\sum }_{( {v}_{i} , {v}_{j} ) , d ; where {v}_{j} is a super \text{-} task} {V}_{h , o} ( {V}_{i} , d ) {V}_{h} ( e , d ) {D}_{m , h} ( {v}_{i} , {v}_{j} , d ) + {V}_{m , o} ( {v}_{i} , d ) {V}_{m} ( e , d ) {D}_{h , m} ( {v}_{i} , {v}_{j} , d )$$

The cost formulator 204 of the illustrated example also establishes a cost formula for communication cost for all edges with data object transfers from and to super-tasks by the following expression.

$${\sum }_{( {v}_{i} , {v}_{j} )} {V}_{h , o} ( {v}_{i} , d ) {V}_{h , i} ( {v}_{j} , d ) {D}_{m , h} ( {v}_{i} , {v}_{j} , d ) + {V}_{m , o} ( {v}_{i} , d ) {V}_{m , i} ( {v}_{j} , d ) {D}_{h , m} ( {v}_{i} , {v}_{j} , d )$$

In the illustrated example, the task scheduling cost is the cost due to task scheduling via remote procedure calls between the main core and helper core(s). For edge e=(vᵢ,vⱼ) in the task graph, if task vᵢ is assigned to the main core (i.e., M(vᵢ)=0) and if task vⱼ is assigned to the helper core(s) (i.e., M(vⱼ)=1), a task scheduling cost of T_{m,h}(vᵢ,vⱼ) is charged to edge e for the overhead time to invoke task vⱼ. For example, the task scheduling cost T_{m,h}(vᵢ,vⱼ) may be the sum of the products of the average time for main-core-to-helper-core(s) task scheduling and the execution count of the control edge e. Similarly, if task vᵢ is assigned to the helper core(s) (i.e., M(vᵢ)=1) and if task vⱼ is assigned to the main core (i.e., M(vᵢ)=0), a task scheduling cost of T_{h,m}(vᵢ,vⱼ) is charged to edge e for the overhead time to notify the main core when task vⱼ completes. The task scheduling cost T_{h,m}(vᵢ,vⱼ) may be the sum of the products of the average time for helper-core(s)-to-main-core task scheduling and the execution count of the control edge e. Thus, for the total task scheduling cost for all tasks is developed by the cost formulator 204 via the following expression.

$${\sum }_{All e = ( {v}_{i} , {v}_{j} ) , d} M ( {v}_{i} ) M ( {v}_{j} ) {T}_{m , h} ( {v}_{i} , {v}_{j} ) + M ( {v}_{j} ) M ( {v}_{i} ) {T}_{h , m} ( {v}_{i} , {v}_{j} )$$

In the illustrated example, the address translation cost is the cost due to the time taken to perform the dynamic bookkeeping function discussed above for an example CMP system with private memory for a main core and each helper core. In this example, for a data object d that is accessed by the main core and one or more helper core(s), an address translation cost A(d) is charged to data object d for the overhead time to perform address translation. For example, the address translation cost A(d) may be the product of the average data registration time and the execution count of the statement that allocates data object d. Thus, the total address translation cost of all data objects shared among the main core and the helper core(s) is determined by the cost formulator 204 via the following expression.

$${\sum }_{All d} {N}_{h} ( d ) {N}_{m} ( d ) A ( d )$$

In the illustrated example, the data redistribution cost is the cost due to the redistribution of misaligned data objects across helper core(s). For example, tasks vᵢ and vⱼ are offloading candidates to helper core(s) with an input dependence from task vᵢ to task vⱼ due to a piece of aggregate data object d. If the distribution of data objects d does not follow the same pattern on both tasks vᵢ and vⱼ, the helper core(s) may store different sections of data object d. In such a case, if vⱼ gets a valid copy of data object d from a task that is assigned to the main core, a cost R(d) may be charged for the redistribution of data object d among the helper core(s). Thus, for the total data redistribution cost of all such data dependencies in data objects d is determined by the cost formulator 204 via the following expression:

$${\sum }_{All ( {v}_{i} , {v}_{j} ) , d} M ( {v}_{i} ) M ( {v}_{j} ) {V}_{h , o} ( {v}_{i} , d ) {V}_{h , i} ( {v}_{j} , d ) R ( d )$$

The task optimizer 206 of the illustrated example allocates each task assignment decision by solving a minimum-cut network flow problem. The minimum-cut (maximum-flow) theorem described in, for example, Cheng Wang and Zhiyuan Li, Parametric Analysis for Adaptive Computation Offloading, In Proceedings of ACM SIGPLAN Conference on Programming Language Design and Implementation, PLDI '04. ACM Press, New York, N.Y., 119-130. To solve the minimum-cut network flow problem, the task optimizer 206 of FIG. 2 establishes the cost terms discussed above (e.g., Cₘ(v), Cₕ(V), D_{m,h}, D_{h,m}, T_{m,h}, T_{h,m}, A(d), R(d)) for possible run time values. The task optimizer 206 solves the minimum-cut theorem by setting the Boolean variables (e.g., M, V_{m,i}, V_{m,o}, V_{h,i}, V_{h,o}, Nₘ, Nₕ,) to conditional values, which minimize the total cost formulas subject to the constraints discussed above (e.g., read constraints, write constraints, transitive constraints, conservative constraints, and data-access state constraints). Thus, the task optimizer 206 determines assignment decisions for each task (e.g., M(v)) which may possibly be run time values, which are expressed as input parameters. During run time, the input parameters are provided via the conditional statement and compared against the cost terms established by the task optimizer 206 to determine the task assignment decision for each task (e.g., M(v)). After making the assignment decisions, the task optimizer 206 compiles the object code.

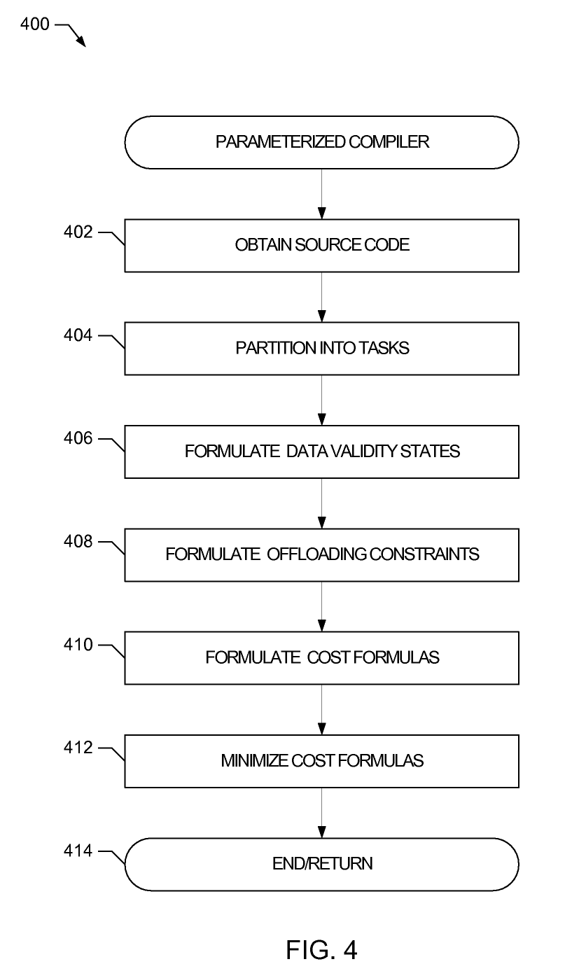

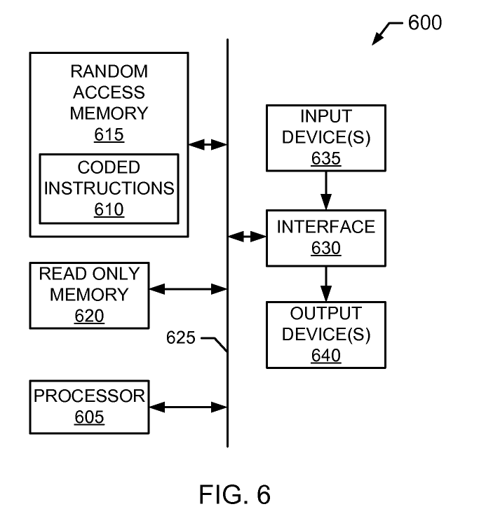

Flow diagrams representative of example machine readable instructions which may be executed to implement the example parameterized compiler 104 of FIG. 1 are shown in FIG. 4. In these examples, the instructions may be implemented in the form of one or more example programs for execution by a processor, such as the processor 605 shown in the example processor system 600 of FIG. 6. The instructions may be embodied in software stored on a tangible medium such as a CD-ROM, a floppy disk, a hard drive, a digital versatile disk (“DVD”), or a memory associated with the processor 605, but persons of ordinary skill in the art will readily appreciate that the entire processes and/or parts thereof could alternatively be executed by a device other than the processor 605 and/or embodied in firmware or dedicated hardware in a well known manner. For example, any or all of the example parameterized compiler 104 of FIG. 1, the task partitioner 200 of FIG. 2, the data tracer 202 of FIG. 2, and/or the cost formulator 204 of FIG. 2 may be implemented by firmware, hardware, and/or software. Further, although the example instructions are described with reference to the flow diagrams illustrated in FIG. 4, persons of ordinary skill in the art will readily appreciate that many other methods of implementing the example instructions may alternatively be used. For example, the order of execution of the blocks may be changed, and/or some of the blocks described may be changed, eliminated, or combined. Similarly, the execution of the example instructions and each block in the example instructions can be performed iteratively.

The example instructions 400 of FIG. 4 begins by obtaining source code, which may be in any computer language, including a human-readable source code or machine executable code (block 402). The task partitioner 200 of FIG. 2 of the example parameterized compiler 104 of FIG. 1 then partitions the source code into tasks (block 404). The tasks are partitioned by identifying control flow statements (e.g., a branch instruction, an instruction following a branch instruction, a target instruction of a branch instruction, function calls, return instructions, and/or any other type of control transfer instruction) and/or function calls. The remaining portion of the source code (such as the starting instruction sequence of a function) is partitioned into a task represented by a super-task. The tasks are represented in a graph, which reflects the control flow conditions for each task. The example data tracer 202 of FIG. 2 inserts conditional statements, such as, for example an if statement that compares the input parameters against the predetermined cost terms to choose the task assignment decision for one or more partitioned tasks. Also, the example data tracer 202 inserts content transfer message(s) and control transfer message(s), which, when executed, offloads one or more partitioned tasks and signals a control transfer of one or more tasks to the helper core(s) after the conditional statement evaluates the task assignment decision and determines the value to represent an offload decision. Control transfer message(s), which, when executed, signal a control transfer of one or more tasks to the main core after the helper core completes an offloaded task are inserted after one or more tasks.

After partitioning the source code into tasks (block 404), the example cost formulator 204 of FIG. 2 creates data validity states to evaluate the data dependencies for each data object that is accessed by multiple tasks among the partitioned tasks of the source code (block 406). The example cost formulator 204 then creates offloading constraints from the data validity states including read constraints, write constraints, transitive constraints, conservative constraints, and data-access state constraints (block 408).

The example cost formulator 204 creates cost formulas using the input parameters or constant(s) and the data validity states (block 410). The cost formulas establish computation, communication, task-scheduling, address-translation, and data-redistribution cost formulas for the source code. The input parameters used in the cost formulas may be structured to obtain an array or vector that includes, for example, the size of the data or instructions associated with partitioned tasks.

The example cost formulator 204 minimizes the cost formulas by a minimum-cut algorithm, which determines the task assignment decisions for each task for the possible run-time input parameters (block 412). The minimum-cut network flow algorithm establishes the possible run-time input parameters as cost terms, which may be constants or formulated as an input vector, and solves the minimum-cut theorem to the assignment decisions (e.g., a Boolean variable to either offload one or more tasks or not offload the tasks) to a value subject to the constraints discussed above (e.g., read constraints, write constraints, transitive constraints, conservative constraints, and data-access state constraints). Thus, the conditional statement, when executed, compares the run-time input parameters against the solved cost terms to determine the Boolean values of the task assignment decisions. The result of the comparison indicates whether to offload or not offload one or more partitioned tasks. The example task optimizer 206 of FIG. 2 returns an object code that includes parameterized offloading (block 414).

FIG. 5 illustrates an example chip multiprocessor (“CMP”) system 500 that may execute the object code 106 of FIG. 1 that includes parameterized offloading. The system 500 includes two or more processor cores 502a and 502b in a single chip package 504, but, as stated above, the teachings of this disclosure can be readily adapted to other MP architectures including MS-MP architectures. The optional nature of processors in excess of processor cores 502a and 502b (e.g., processor core 502n) is denoted by dashed lines in FIG. 1. For example, processor core 502a may be implemented as a main core, as described above, and processor core 502b may be implemented as a helper core, as described above. Each core 502 includes a private level one (“L1”) instruction cache 506 and a private L1 data cache 508. Persons of skill in the art will recognize that the example topology shown in system 500 may correspond with many different physical and communication couplings among the example memory hierarchies and processor cores and that other topologies would likewise be appropriate.

In addition, each core 502 may also include a private unified second level 2 (“L2”) cache 510. Accordingly, the private L2 cache 510 is responsible for participating in cache coherence protocols, such as, for example, a MESI, MOESI, write-invalidate, and/or any other type of cache coherence protocol. Because the private caches 510 for the multiple cores 502a-502n are used with shared memory such as shared memory system 520, the cache coherence protocol is used to detect when data in one core's cache should be discarded or replaced because another core has updated that memory location and/or to transfer data from one cache to another to reduce calls to main memory.

The example system 500 of FIG. 5 also includes an on-chip interconnect 512 that manages communication among the processor cores 502a-502n. The processor cores 502a-502n are connected to a shared memory system 520. The memory system 520 includes an off-chip memory 502. The memory system 520 may also include a shared third level (“L3”) cache 522. The optional nature of the shared on-chip L3 cache 522 is denoted by dashed lines. For example implementations that include optional shared L3 cache 522, each of the processor cores 502a-502n may access information stored in the L3 cache 522 via the on-chip interconnect 512. Thus, the L3 cache 522 is shared among the processor cores 502a-502n of the system 500. The L3 cache 522 may replace the private L2 caches 510 or provide cache in addition to the private L2 caches 510.

The caches 506a-506n, 508a-508n, 510a-510n, 522 may be any type and size of random access memory device to provide local storage for the processor cores 502a-502n. The on-chip interconnect 512 may be any type of interconnect (e.g., interconnect providing symmetric and uniform access latency among the processor cores 502a-502n). Persons of skill in the art will recognize that the interconnect 512 may be based on a ring or bus or mesh etc topology to provide symmetric access scenarios similar to those provided by uniform memory access (“UMA”) or asymmetric access scenarios similar to those provided by non-uniform memory access (“NUMA”).

The example system 500 of FIG. 5 also includes an off-chip interconnect 524. The off-chip interconnect 524 connects, and facilitates communication between, the processor cores 502a-502n of the chip package 504 and an off-core memory 526. The off-core memory 526 is a memory storage structure to store data and instructions.

As used herein, the term “thread” is intended to refer to a set of one or more instructions. The instructions of a thread are executed by a processor (e.g., processor cores 502a-502n). Processors that provide hardware support for execution of only a single instruction stream are referred to as single-threaded processors. Processors that provide hardware support for execution of multiple concurrent threads are referred to as multi-threaded processors. For multi-threaded processors, each thread is executed in a separate thread context, where each thread context maintains register values, including an instruction counter, for its respective thread. The example CMP system 500 discussed herein may includes a single thread for each of processor(s) 506, but this disclosure is not limited to single-threaded processors. The techniques discussed herein may be employed in any MP system, including those that include one or more multi-threaded processors in a CMP architecture or a MS-MP architecture.

FIG. 6 is a schematic diagram of an example processor platform 600 that may be used and/or programmed to implement the parameterized compiler 104 of FIG. 1. More particularly, any or all of the task partitioner 200 of FIG. 2, data tracer 202 of FIG. 2, and/or the cost formulator 204 of FIG. 2 may be implemented by the example processor platform 600. In addition, the example processor platform 600 may be used and/or programmed to implement the example CMP system 500 of FIG. 5 and/or a portion of an MS-MP system. For example, the processor platform 600 can be implemented by one or more general purpose single-thread and/or multi-threaded processors, single-core and/or multi-core processors, microcontrollers, etc. The processor platform 600 may also be implemented by one or more computing devices that contain any type of concurrently-executing single-thread and/or multi-threaded processors, single-core and/or multi-core processors, microcontrollers, etc.

The processor platform 600 of the example of FIG. 6 includes at least one general purpose programmable processor 605. The processor 605 executes coded instructions 610 present in main memory of the processor 605 (e.g., within a random-access memory (“RAM”) 615). The coded instructions 610 may be used to implement the instructions represented by the example processes of FIG. 4. The processor 605 may be any type of processing unit, such as a processor core, processor and/or microcontroller. The processor 605 is in communication with the main memory (including a read-only memory (“ROM”) 620 and the RAM 615) via a bus 625. The RAM 615 may be implemented by dynamic RAM (“DRAM”), Synchronous DRAM (“SDRAM”), and/or any other type of RAM device, and ROM may be implemented by flash memory and/or any other desired type of memory device. Access to the memory 615 and 620 may be controlled by a memory controller (not shown).

The processor platform 600 also includes an interface circuit 630. The interface circuit 630 may be implemented by any type of interface standard, such as an external memory interface, serial port, general purpose input/output, etc. One or more input devices 635 and one or more output devices 640 are connected to the interface circuit 630.

Although this patent discloses example systems including software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example systems, methods and articles of manufacture, persons of ordinary skill in the art will readily appreciate that the examples are not the only way to implement such systems, methods and articles of manufacture. Therefore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method comprising:
partitioning source code into a first task and a second task; and
compiling object code from the source code, such that the first task is compiled to execute on a first processor core and the second task is compiled to execute on a second processor core, the assignment of the first task to the first core being dependent on an input parameter.

2. A method as defined in claim 1, wherein the input parameter is associated with data input during execution of the object code.

3. A method as defined in claim 1, wherein the input parameter comprises at least one of a computation cost, a data transfer cost, a task scheduling cost, an address translation cost, or a data redistribution cost.

4. A method as defined in claim 1, further comprising partitioning the source code into the first task or the second task.

5. A method as defined in claim 3, further comprising assigning task assignment decisions to each of the first task and the second task.

6. A method as defined in claim 3, further comprising formulating data validity states for a data object shared among the first task and the second task.

7. A method as defined in claim 1, wherein compiling the object code further comprises:
assigning task assignment decisions to each of the first task and the second task;
formulating a data validity state for a data object shared among the first task and the second task;
formulating an offloading constraint from the data validity state;
formulating a cost formula for the first task; and
minimizing the cost formula to determine a task assignment decision subject to the offloading constraint and the input parameter.

8. An apparatus comprising:
a task partitioner to identify a first task and a second task in source code; and
a task optimizer to compile object code from the source code, such that the first task is compiled to execute on a first processor core and the second task is compiled to execute on a second processor core, the assignment of the first task to the first core being dependent on an input parameter.

9. An apparatus as defined in claim 8, wherein the input parameter is associated with data input during execution of the object instruction.

10. An apparatus as defined in claim 8, wherein the input parameter comprises at least one of a computation cost, a data transfer cost, a task scheduling cost, an address translation cost, or a data redistribution cost.

11. An apparatus as defined in claim 8, wherein the task partitioner is to partition the source code into the first task and the second task.

12. An apparatus as defined in claim 11, further comprising a task optimizer to assign task assignment decisions to each of the first task and the second task.

13. An apparatus as defined in claim 11, further comprising a cost formulator to formulate data validity states for a data object shared among the first task and the second task.

14. An apparatus as defined in claim 11, further comprising:
a task optimizer to assigning task assignment decisions to each of the first task and the second task;
a cost formulator to formulate a data validity state for a data object shared among the first task and the second task, formulate an offloading constraint from the data validity state, formulate a cost formula for the first task, and minimize the cost formula to determine a task assignment decision subject to the offloading constraint and the input parameter.

15. An article of manufacture storing machine readable instructions which, when executed, cause a machine to:
partition source code into a first task and a second task; and
compile object code from the source code, such that the first task is compiled to execute on a first processor core and the second task is compiled to execute on a second processor core, the assignment of the first task to the first core being dependent an more input parameter.

16. An article of manufacture as defined in claim 15, wherein the input parameter is associated with data input during execution of the object code.

17. An article of manufacture as defined in claim 15, wherein the input parameter comprises at least one of a computation cost, a data transfer cost, a task scheduling cost, an address translation cost, or a data redistribution cost.

18. An article of manufacture as defined in claim 15, wherein the machine readable instructions further cause the machine to assign task assignment decisions to at least one of the first task and the second task.

19. An article of manufacture as defined in claim 15, wherein the machine readable instructions further cause the machine to formulate data validity states for a data object shared among the first task and the second task.

20. An article of manufacture as defined in claim 15, wherein compiling the object code further comprises:
assigning task assignment decisions to at least one of the first task and the second task;
formulating a data validity state for a data object shared among the first task and the second task;
formulating an offloading constraint from the data validity state;
formulating a cost formula for the first task; and
minimizing the cost formula to determine a task assignment decision subject to the offloading constraint and the input parameter.
